(19) United States
(12) Patent Application Publication
(10) Pub. No.: US 2003/0042689 A1
(43) Pub. Date: Mar. 6, 2003

(54) Cylinder head gasket

(76) Inventors: Armin Diez, Lenningen (DE); Frank Schmucker, Ehingen (DE); Ulrich Werz, Dettingen (DE)

Correspondence Address: Alix, Yale & Ristas, LLP, Suite 1400, 750 Main Street, Hartford, CT, 06103-2721, US

(21) Appl. No.: 10/235,156

(22) Filed: Sep. 4, 2002

(30) Foreign Application Priority Data
Sep. 5, 2001 (DE) 101 43 431.6

(51) Int. Cl. F02F 11/00

(52) U.S. Cl. 277/593

(57) ABSTRACT

The invention relates to a metallic cylinder-head gasket for an internal combustion engine which has a cylinder block having adjacent combustion chambers and has a cylinder head screwed to said cylinder block, with at least one cover plate made of elastic metal and a carrier plate, which are arranged one above the other and are provided with a plurality of combustion-chamber orifices corresponding to the combustion chambers of the internal combustion engine, a bead being provided around each combustion-chamber orifice at a distance from the latter, so as to leave a sheet-metal edge portion in the orifice-edge region, the spring stroke of said bead being limited by at least one deformation limiter arranged concentrically to the bead in the axial region of the sheet-metal edge portion and/or in the axial region radially on the outside in relation to the bead, a support element formed separately from the deformation limiter being provided in the axial region of the deformation limiter at a distance from the edges of the latter and limiting the edge pressure at the radially outer edge of the deformation limiter.

### FIELD OF THE INVENTION

The invention relates to a metallic cylinder-head gasket as it is used in an internal combustion engine between a cylinder block and a cylinder head to seal a gap therebetween.

### BACKGROUND OF THE INVENTION

European patents EP 0 306 766 B1 and EP 0 230 804 B1 disclose a metallic cylinder head gasket for an internal combustion engine, in which a carrier plate, together with at least one beaded elastic cover plate, the latter as a functional plate, are provided. Since the sealing gap between the cylinder head and cylinder block of an internal combustion engine changes, during operation, as a function of the work cycle of the cylinder considered in each case, the gasket is subjected to constant pressure changes and must have permanent spring properties in order to maintain satisfactory sealing-off. For this purpose, the bead running around the respective combustion-chamber orifice and acting as a spring element is protected by a spring-stroke limiter or stopper which is arranged along the combustion-chamber edge and which limits the spring stroke of the bead which follows the relative movements of the cylinder head with respect to the cylinder block which occur and take place vertically in relation to the sealing plane, so that the bead moves only within the spring stroke range provided for it, cannot be pressed flat and also does not spring up to too great an extent. For the relieving of the bead also should not be complete, but take place only to a degree such that, at the highest possible combustion-space pressure which occurs, a minimum deformation ensures the necessary sealing-off. The spring stroke limiter forms an elevation of the cylinder-head gasket, said elevation extending along the combustion-chamber edge.

However, in the edge region of the spring-stroke limiter, very high edge pressures occur on account of the flexion of the cylinder block and cylinder head as engine components, and there is therefore locally, in this region, high static material stress on the cylinder block, cylinder head and cylinder-head gasket or corresponding deformations. During ignition, the edge region of the spring stroke limiter is relieved. This leads to high stress amplitudes in this region. In high-performance engines, above all, it is possible that, during ignition, contact is lost in the region of the spring stroke limiter. This results correspondingly, in addition to the static stress in the edge region of the spring stroke limiter, in a dynamic stress, since very high stress amplitudes take effect. The risk of cracking on the engine components is thereby increased markedly. The same applies correspondingly to an edge which is formed on a carrier plate as a result of bending, in order to implement the spring stroke limiter and corresponding carrier-plate portion between the beaded cover plates, as described in EP 0 306 766 B1.

Apart from this, when contact is lost in the region of the spring-stroke limiter, hot combustion gases can pass, unimpeded, as far as the actual sealing-off point which is formed by the spring-steel bead. As a result, because of the high temperature, the spring property of the bead is and therefore its sealing action may be diminished.

In bush-type engines, specifically, in particular, in those which have pressed-in bushes, there is the additional fact that a gap between the bush and the cylinder block occurs under adverse conditions, for example as a consequence of manufacture or because of unfavourable operating conditions of the engine. Consequently, during ignition, hot combustion gas can pass, unimpeded, into the gap between the cylinder block and bush.

### SUMMARY OF THE INVENTION

It is an object of the invention is to provide a cylinder-head gasket, in which the edge pressure in the region of the deformation limiter is appreciably reduced.

The invention provides a metallic cylinder head gasket for an internal combustion engine, said engine comprising a cylinder block provided with adjacent combustion chambers and a cylinder head screwed to said cylinder block, said gasket comprising:

at least one cover plate made of elastic metal and a carrier plate, said plates being arranged one above the other and are provided with a plurality of combustion-chamber orifices corresponding to the combustion chambers of the internal combustion engine,

a bead extending around each combustion-chamber orifice at a distance from the latter, so as to leave a sheet-metal edge portion in the orifice-edge region,

a deformation limiter limiting the spring stroke of said bead and being arranged concentrically to said bead in one of a radially inside and outside reagion of said bead,

wherein a support element formed separately from the at least one deformation limiter is provided in the axial region of the at least one deformation limiter and at a distance from the edges of the latter and limits the edge pressure at the radially outer edge of the at least one deformation limiter.

Since an additional, expediently narrow and essentially linearly acting support element which cannot be pressed flat is provided radially inwards from the respective annular bead forming the actual sealing-off point, in the axial region in which the associated statically acting spring-stroke limiter is arranged, and at a distance from the edges of the latter, the transmission of force can be shifted in the direction of the centre of the spring-stroke limiter, so that the edge pressure and consequently the static stress on the engine components are greatly reduced.

As was recognized by the inventors, in particular, the beaded cover plate facing the cylinder head is displaced, during the ignition, somewhat in the radial direction (with respect to the combustion-chamber orifice) as a result of corresponding friction. The cover plate is thereby displaced in relation to the radially outer edge of the spring-stroke limiter or a bend of the carrier plate, with the result that this region is subjected to the action of force virtually between maximum force and zero and therefore undergoes particularly high stress. The support element has the effect, however, that, when the internal combustion engine is in operation, there are no substantial displacements in the radial direction (with respect to the combustion-chamber orifice) between the beaded cover plate and the deformation limiter or the intermediate layer located between the cover plates, since the pressure force is distributed to a larger bearing surface, so that the partial pressure decreases. The risk of cracking of the cover plate is thereby reduced considerably or eliminated.

The situation of excessive edge pressure and therefore the risk of cracking of the cover plates may also arise, in bush-type engines in which the deformation limiter projects radially beyond the respective bush, in the region of the outer edges of the bushes, since the cylinder block, made, for example, from an aluminium alloy, as a result of being heated during operation, presses the bushes somewhat in the direction of the cylinder block, so that they project somewhat and form a corresponding edge at which the edge pressure is particularly high. The support element, which must then be located in the region between this edge and the combustion-chamber edge, likewise provides a remedy here.

The support element also prevents the bead from having excessively high dynamics by removing part of the action of force from the latter.

The provision of the support element is expedient, in particular, in the case of large heights of the deformation limiter of, for example, >0.12 mm.

Moreover, the support element may be designed resiliently. As a result, in the region of the deformation limiter, the additional sealing-off point thus formed can be sealed off with respect to hot combustion gas under combustion pressure relative to the outside and consequently relative to the bead forming the actual sealing-off point. The sealing gap of the combustion-chamber edge is therefore kept permanently closed under the engine operating condition. It is thereby possible, in bush-type engines, to avoid this situation where hot combustion gas penetrates into a gap between the bush and the cylinder block.

Further objects, advantages and embodiments of the invention may be gathered from the following description.

### BRIEF DESCRIPTION OF THE DRAWINGS

The invention is explained in more detail below with reference to exemplary embodiments illustrated in the accompanying figures.

FIG. 1 shows in the form of a detail, and in section, one embodiment of a cylinder-head gasket of the invention in the non-tensioned state.

FIGS. 1a and 1b show graphs relating to the pressure profile in the area of the deformation limiter of the embodiment of FIG. 1.

FIGS. 2 to 8 show further embodiments of the invention in the form of a detail and in section, FIGS. 4 to 8 being highly diagrammatic.

### DETAILED DESCRIPTION OF PREFERRED EMBODIMENTS

The cylinder-head gasket illustrated in FIG. 1 comprises two essentially planar cover plates 1 consisting of elastic metal, in particular spring steel, between which an essentially planar carrier plate 2 made of sheet steel is arranged. The cover plates 1 and the carrier plate 2 are provided with a plurality of combustion-chamber orifices 3 corresponding to the combustion chambers 4 of an associated internal combustion engine which has a cylinder block 5 and a cylinder head 6 screwed to the latter, with the cylinder head gasket interposed. A bead 8 is provided around each combustion-chamber orifice 3 at a distance from the latter, so as to leave a sheet-metal edge portion 7 in the orifice-edge region, the beads 8 facing one another with their vertices. The spring stroke of the beads 8 is limited by at least one static deformation limiter 9 arranged concentrically to the respective bead 8 in the axial region of the sheet-metal edge portion 7. In FIG. 1, the carrier plate 2 is expediently provided with a bend 10 in the region of the sheet-metal edge portions 7, so as to form an annular portion 11 which is offset with respect to the carrier plate 2 and runs around the combustion-chamber edge and into which the annular deformation limiter 9 is inserted, so that the latter, together with the annular portion 11, forms a thickened portion which is located essentially centrally between the cover plates 1.

The cover plate 1 facing the cylinder head 6 possesses, in the region of the deformation limiter 9, an additional support element 12 which cannot be pressed flat. The support element 12 may be designed statically, for example as a bulbous coating, for example in the form of a welding bead or the like, or else elastically, that is to say as an additional spring element in the form of a slight outwardly directed bend (as illustrated in FIG. 1) or as a half-bead.

When the cylinder head 6 is braced together with the cylinder block 5, the beads 8 are flattened until the cover plates 1 come to bear on the thickened portion formed by the deformation limiter 9 and the annular portion 11.

Without the additional support element 12 (illustrated by broken lines in FIG. 1), there would then be a distribution of pressure in the region of the deformation limiter 9, as illustrated in FIG. 1a. In this case, because of the deformation of the cylinder head 6 and of the cylinder block 5, which, during the tensioning of the cylinder-head gasket as a result of the deformation limiter 9, leads to a sealing gap opening slightly conically towards the combustion chamber 4 between the cylinder head 6 and the cylinder block 5, the pressure at the combustion-chamber edge is at its lowest and then rises as far as the edge of the bend 10 or of the deformation limiter 9 when there is no ignition pressure taking effect (curve A). Very high edge pressure therefore occurs at the radially outer edge of the deformation limiter 9 or the radially inner edge of the bend 10. During ignitions, that is to say when the ignition pressure takes effect, relief occurs (curve B), which may go as far as zero. This leads to high stress amplitudes in this region. In high-performance engines, above all, it is possible that contact is lost in this region during ignition, so that, in addition to the high static stress, there is then also a very high dynamic stress which markedly increases the risk of cracking on the components.

The additional support element 12 results in a lower edge pressure and, instead, maximum pressure distribution and therefore force transmission in the region of the support element 12, specifically, preferably, in the middle region of the deformation limiter 9, cf. FIG. 1b, curves A′ and B′, indeed both with and without ignition pressure. The stress amplitude at the outer edge of the deformation limiter 9, which varies between zero and the maximum edge pressure there, is therefore reduced by means of the additional support element 12. Although, here too, the ignition pressure generally leads to relief, a small residual force of the resilient support element 12 nevertheless remains, which is sufficient to seal off the sealing gap in spite of the relief brought about by the ignition pressure. Both the static and the dynamic material stress are thereby markedly reduced.

The additional sealing-off also avoids the situation where hot combustion gases pass, unimpeded, as far as the actual sealing-off point formed by the beads 8 and could reduce the spring force of the beads 8 on account of the high temperature.

In bush-type engines in which the combustion chambers 4 are formed by bushes 13 inserted into the cylinder block 5, the additional sealing-off also avoids the situation where hot combustion gases may pass into a gap between the cylinder block 5 and the bush 13 which occurs as a consequence of manufacture or because of unfavourable operating conditions. In the case of a bush projection, that is to say when the bush 13 projects somewhat from the cylinder block 5, and when the deformation limiter 9 extends radially outwards beyond the bush 13, the support element 12 is arranged in the preferably essentially middle region of the bush 13.

The force to be applied by the additional resilient support element 12 is generally in the range of about 30 to 60 N/mm under the engine operating condition (maximum ignition pressure).

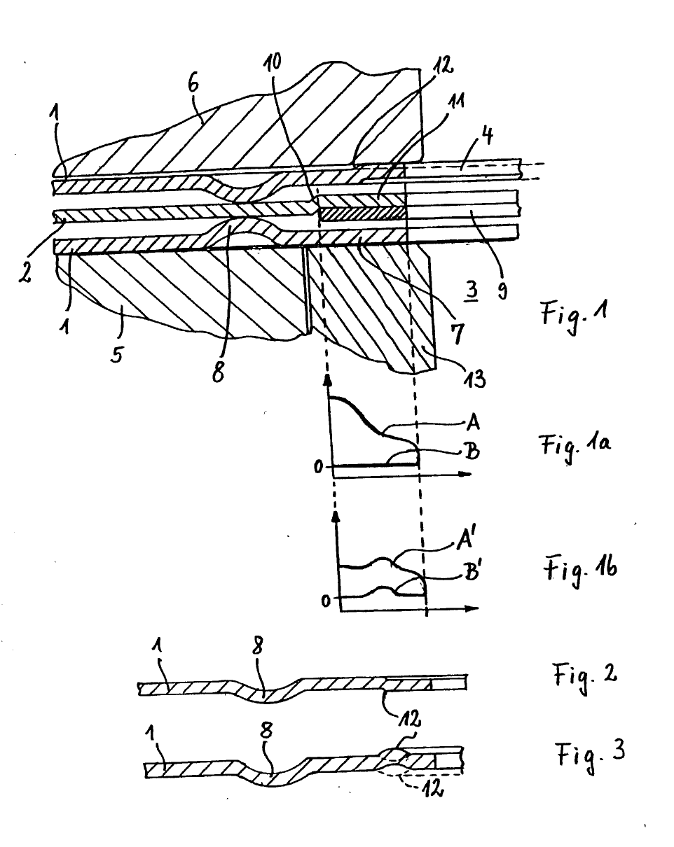

As is clear from FIG. 2, the bend forming the additional support element 12 may also be directed towards the carrier plate 2.

As is evident from FIG. 3, the additional support element 12 may also be designed in the form of a small full bead and, if appropriate, also face the carrier plate 2 (the latter option being indicated by broken lines in FIG. 3).

Instead of being formed on the cover plate 1 facing the cylinder head 6, the support element 12 may also be formed on the cover plate 1 facing the cylinder block 5. Instead, the support element 12 may also be provided on both cover plates 1.

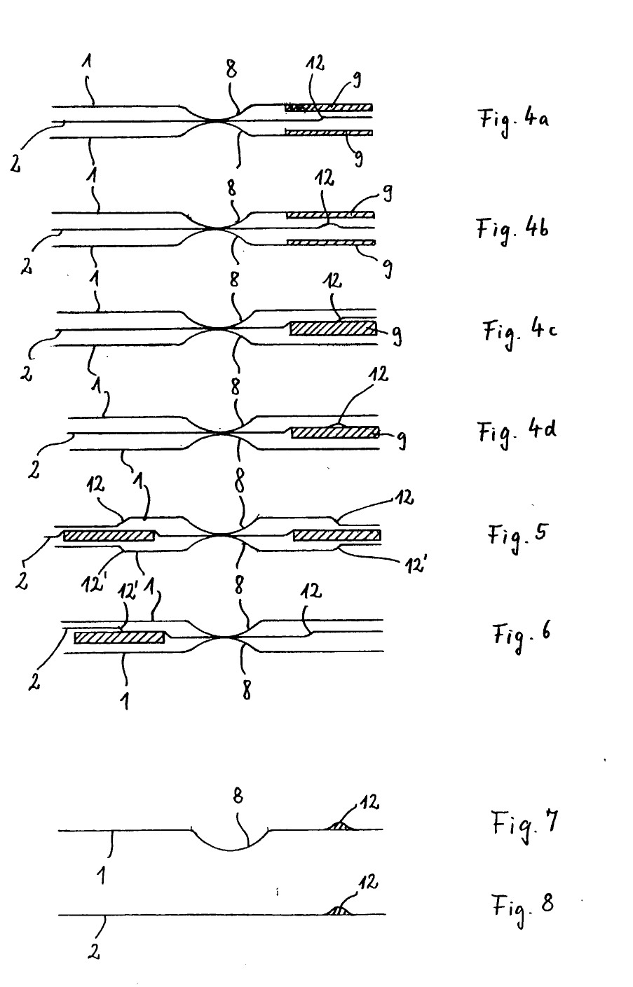

As is clear from FIGS. 4a to 4d, the support element 12 may also be provided, in the form of a small half-bead or full bead, in the carrier plate 2, manufactured from elastic sheet steel, in the region of one deformation limiter 9 or of two deformation limiters 9 located on the cover plates 1.

When deformation limitation of the beads 8 is provided on the side of the beads 8 which faces away from the combustion-chamber orifice 4 by means of one central deformation limiter 9 located on the carrier plate 2 or two deformation limiters 9 arranged on the cover plates 1, alone or in addition to the combustion-chamber-side deformation limitation of the beads 8, according to the respective internal combustion engine, a corresponding support element 12′ designed as a small bend or full bead may be provided on the side facing away from the beads 8, cf. FIG. 5, 6.

When the support element 12 is designed as a bend or as a small full bead in the carrier plate 2, if the carrier plate 2 consists of the steel used conventionally for this purpose, said support element is deformed partially plastically during tensioning, but the bend or full bead cannot be pressed away completely. However, the height of the bend or the shape of the full bead must be selected such that a sufficient height remains to achieve optimum support.

As used herein, “bend” should be understood as specifically including the parallel offset shown in the Figures as well as functional equivalents that fall within the colloquial term “crink”.

As is clear from FIGS. 7 and 8, the support element 12 may also be provided as an inelastic bulbous coating, for example as a welding bead, on the cover plate 1 or the carrier plate 2.

When the cylinder-head gasket is in the tensioned state the additional support element 12, 12′ exerts as narrow essentially linear pressure which is effective, for example, in the middle region of the respective deformation limiter 9.

Moreover, the deformation limiter 9 may be profiled in terms of height and/or width according to the pressure reductions to be expected in specific regions on account of the diminished component rigidity of the cylinder block 5 and cylinder head 6 in the tensioned state of the cylinder-head gasket.

While the invention has been shown and describes with reference to preferred embodiments, it should be apparent to one ordinary skilled in the art that many changes and modifications may be made without departing from the spirit and scope of the invention as defined in the claims.

What is claimed is:

1. A metallic cylinder head gasket for an internal combustion engine having a cylinder block provided with adjacent combustion chambers and a cylinder head screwable onto the cylinder block comprising:
at lest one cover plate made of elastic metal and a carrier plate, said plates being arranged one above the other and provided with a plurality of combustion chamber orifices for concentric alignment with respective combustion chambers of the internal combustion engine, whereby each orifice has an edge that will surround an edge of a respective combustion chamber,
a spring bead formed in said cover plate and extending around each combustion chamber orifice at a distance from the edge of the orifice, so as to leave a sheet-metal edge portion of said cover plate between the bead and the edge of the orifice,
a deformation limiter arranged concentrically to said bead, extending between radially inner and outer edges and having a middle region, for limiting the spring stroke of said bead, by limiting the displacement of said cover plate relative to the carrier plate when the cylinder head is screwed onto the cylinder block, and
a support element formed separately from the deformation limiter and overlying the deformation limiter, for relieving pressure at the radially outer edge of the deformation limiter when the cylinder head is screwed onto the cylinder block.

2. The cylinder head gasket of claim 1, wherein each support element is situated in axial alignment with the middle region of the respective deformation limiter.

3. The cylinder head gasket of claim 1, wherein each bead is surrounded by a radially outer deformation limiter and a radially inner deformation limiter.

4. The cylinder head gasket of claim 1, wherein the radially inner edge of the deformation limiter ends at the respective combustion chamber orifice.

5. The cylinder head gasket of claim 1, wherein the deformation limiter is fastened at one of the at least one cover plate and the carrier plate.

6. The cylinder head gasket of claim 1, wherein when the cylinder head gasket is screwed into the internal combustion engine and thereby achieves a tensioned state, the support element exert a force acting within a narrow, essentially line-shaped area.

7. The cylinder head gasket of claim 6, wherein the spring force acts within the middle region of the deformation limiter.

8. The cylinder head gasket of claim 1, wherein the support element is elastic.

9. The cylinder head gasket of claim 1, wherein the support element is one of a full or a half bead.

10. The cylinder head gasket of claim 1, wherein the support element has sufficient spring force for keeping the sealing gap between the cylinder block and the cylinder head closed under the action of ignition pressure.

11. The cylinder head gasket of claim 1, wherein the support element is in the form of a coating on said cover plate.

12. The cylinder head gasket of claim 1, wherein the support element is provided at the at least one cover plate.

13. The cylinder head gasket of claim 1, wherein the support element is provided at the carrier plate.

14. The cylinder head gasket of claim 1, wherein the engine is a bush-type engine, the deformation limiter extends radially outwards beyond the respective bush, and the support element is arranged in axial alignment with said bush.

15. The cylinder head gasket of claim 1, wherein the support element is in the form of a bend in one of the at least one cover plate or the carrier plate.

16. The cylinder head gasket of claim 1, wherein the support element includes a bend that forms a parallel offset

17. The cylinder head gasket of claim 1, wherein the deformation limiter is supported by said carrier plate, between two cover plates, and the support element is in the form of one of a bend or bead in the carrier plate where the carrier plate supports the deformation limiter.

18. The cylinder head gasket of claim 1, wherein the deformation limiter is profiled in terms of at least one of height and width according to pressure reductions to be expected in specific regions on account of diminished component rigidity of the cylinder block and cylinder head in the tensioned state of the cylinder head gasket.
